(19) United States
(12) Patent Application Publication
(10) Pub. No.: US 2017/0128785 A1
(43) Pub. Date: May 11, 2017

(54) MULTI-LAYER GOLF BALL

(71) Applicant: Acushnet Company, Fairhaven, MA (US)

(72) Inventors: Michael J. Sullivan, Old Lyme, CT (US); Mark L. Binette, Mattapoisett, MA (US); Robert Blink, Newport, RI (US); David A. Bulpett, Boston, MA (US); Brian Comeau, Berkley, MA (US)

(73) Assignee: Acushnet Company, Fairhaven, MA (US)

(21) Appl. No.: 14/936,743

(22) Filed: Nov. 10, 2015

(51) Int. Cl. A63B 37/00; C08L 33/08

(52) U.S. Cl. CPC A63B 37/0051; C08L 33/08; A63B 37/0059; A63B 37/0074; A63B 37/0075; A63B 37/0039

(57) ABSTRACT

Golf balls having at least one layer formed from a thermoplastic composition comprising a polymeric (meth) acrylate plasticizer are disclosed.

### FIELD OF THE INVENTION

The present invention generally relates to multi-piece golf balls comprising an inner core layer, an optional intermediate layer, and an outer cover layer. At least one of the layers is formed from a thermoplastic composition comprising a polymeric (meth) acrylate plasticizer.

### BACKGROUND OF THE INVENTION

Plasticizers are known to improve the flexibility and resilience of thermoplastic compositions used to form golf ball layers. Conventional plasticizers, however, can migrate within, bloom to the surface of, and bleed out of a layer, potentially changing the properties of the layer formed from the plasticized composition and adjacent layers. Adhesion problems between the layer formed from the plasticized composition and adjacent layers can also result.

Thus, there is a need for a non-migrating plasticizer that is compatible with thermoplastic golf ball compositions. The use of a non-migrating plasticizer in thermoplastic golf ball compositions may provide golf balls with one or more of the following benefits: increased resilience, improved durability, and better property stability over time.

### SUMMARY OF THE INVENTION

The present invention provides multi-piece golf balls comprising an inner core layer, an optional intermediate layer, and an outer cover layer. At least one of the layers is formed from a thermoplastic composition comprising a polymeric (meth) acrylate plasticizer.

In one embodiment, the inner core layer is formed from a thermoplastic composition comprising a polymeric (meth) acrylate plasticizer.

In another embodiment, the golf ball includes an intermediate layer disposed between the inner core layer and the outer cover layer, and the intermediate layer is formed from a thermoplastic composition comprising a polymeric (meth) acrylate plasticizer.

### DETAILED DESCRIPTION

Golf balls of the present invention include one-piece, two-piece (i.e., a core and a cover), multi-layer (i.e., a core of one or more layers and a cover of one or more layers), and wound golf balls, having a variety of core structures, intermediate layers, covers, and coatings. Golf ball cores may consist of a single, unitary layer, comprising the entire core from the center of the core to its outer periphery, or they may consist of a center, or inner core layer, surrounded by at least one outer core layer. The center, innermost portion of the core may be solid, hollow, or liquid-, gel-, or gas-filled. The outer core layer may be solid, or it may be a wound layer formed of a tensioned elastomeric material. Golf ball covers may also contain one or more layers, such as a double cover having an inner and outer cover layer. Additional layers may optionally be disposed between the core and cover.

In golf balls of the present invention, at least one layer is formed from a thermoplastic composition comprising a non-migrating polymeric (meth) acrylate plasticizer. For purposes of the present disclosure, the term “non-migrating” means that there will be a minimal amount of loss of the polymeric (meth) acrylate plasticizer from the thermoplastic composition as a result of compatibility issues or in response to an external source, such as heat or solvent extraction. The polymeric (meth) acrylate plasticizer is considered to be compatible with the thermoplastic composition if the plasticizer is able to be mixed into the composition and maintains its position within the composition during mixing, molding, and during use of the part prepared from the composition. For purposes of the present invention, the polymeric (meth) acrylate plasticizer is “substantially non-migratory” if the amount of loss of polymeric (meth) acrylate plasticizer from the thermoplastic composition during mixing, molding, and use of the part prepared from the composition is 10% or less. In a particular embodiment, the amount of loss of polymeric (meth) acrylate plasticizer from the thermoplastic composition during mixing, molding, and use of the part prepared from the composition is less than 10%, or 5% or less, or 3% or less, or 1% or less, or less than 1%.

In one embodiment, the polymeric (meth) acrylate plasticizer is prepared by polymerizing a C₅-C₅₀ alkyl (meth) acrylate, or a mixture of two or more C₅-C₅₀ alkyl (meth) acrylates, in situ, by exposure to, for example, heat, heat with an initiator (e.g., peroxide), ultraviolet light, electron beam, or x-ray, to produce a polymeric (meth) acrylate. For purposes of the present invention, “C₅-C₅₀ alkyl” means a straight chain or branched chain alkyl group having from 5 to 50 carbon atoms per group. For purposes of the present invention, “alkyl (meth) acrylate(s)” refers to alky acrylate(s) and/or alky methacrylate(s). In a particular embodiment, the alkyl (meth) acrylate is selected from the group consisting of 2-ethylhexyl (meth) acrylate, octyl (meth) acrylate, decyl (meth) acrylate, isodecyl (meth) acrylate, undecyl (meth) acrylate, dodecyl (meth) acrylate (also known as lauryl (meth) acrylate), tridecyl (meth) acrylate, tetradecyl (meth) acrylate (also known as myristyl (meth) acrylate), pentadecyl (meth) acrylate, dodecyl-pentadecyl (meth) acrylate, lauryl-myristyl (meth) acrylate, hexadecyl (meth) acrylate, heptadecyl (meth) acrylate, octadecyl (meth) acrylate, nonadecyl (meth) acrylate, cosyl (meth) acrylate, eicosyl (meth) acrylate, cetyl-eicosyl (meth) acrylate, cetyl-stearyl (meth) acrylate, and combinations of two or more thereof.

The polymeric (meth) acrylate typically has a weight average molecular weight, M_{w}, of less than 10,000, or 5,000 or less, or 2,000 or less, or a M_{w}, within a range having a lower limit of 100 or 300 or 500 and an upper limit of 2,000 or 3,000 or 5,000 or 10,000.

The polymeric (meth) acrylate plasticizer is typically present in the thermoplastic composition in an amount of 5 wt % or 10 wt % or 20 wt % or 30 wt % or 40 wt % or 60 wt % or 70 wt %, based on the total polymeric weight of the thermoplastic composition, or an amount having a lower limit and an upper limit selected from these values.

Any suitable thermoplastic may be used in the compositions of the present invention. In one embodiment, the thermoplastic composition comprising the non-migrating polymeric (meth) acrylate plasticizer is a non-ionomeric composition. Suitable non-ionomeric compositions include the following, including homopolymers and copolymers thereof, as well as their derivatives that are compatibilized with at least one grafted or copolymerized functional group, such as maleic anhydride, amine, epoxy, isocyanate, hydroxyl, sulfonate, phosphonate, and the like:
(a) non-ionomeric acid copolymers, particularly O/X- and O/X/Y-type acid copolymers of an α-olefin (O), preferably selected from ethylene and propylene; a C₃-C₈ α,β-ethylenically unsaturated carboxylic acid (X), preferably selected from acrylic, methacrylic, ethacrylic, crotonic, maleic, fumaric, and itaconic acid; and an optional softening monomer (Y) preferably selected from vinyl esters of aliphatic carboxylic acids wherein the acid has from 2 to 10 carbons, alkyl ethers wherein the alkyl group has from 1 to 10 carbons, and alkyl alkylacrylates such as alkyl methacrylates wherein the alkyl group has from 1 to 10 carbons;
(b) polyesters, particularly those modified with a compatibilizing group such as sulfonate or phosphonate, including poly(ethylene terephthalate), poly(butylene terephthalate), poly(propylene terephthalate), poly(trimethylene terephthalate), poly(ethylene naphthenate), and derivatives thereof, including, but not limited to, those disclosed in U.S. Pat. Nos. 6,353,050, 6,274,298, and 6,001,930, the entire disclosures of which are hereby incorporated herein by reference;
(c) polyamides, polyamide-ethers, and polyamide-esters, including, but not limited to, those disclosed in U.S. Pat. Nos. 6,187,864, 6,001,930, and 5,981,654, the entire disclosures of which are hereby incorporated herein by reference;
(d) polyimides, polyetherketones, and polyamideimides;
(e) polyurethanes, polyureas, and copolymers and blends thereof, including, but not limited to, those disclosed in U.S. Pat. Nos. 5,334,673, 5,484,870, 6,506,851, 6,756,436, 6,835,794, 6,867,279, 6,960,630, and 7,105,623, U.S. Patent Application Publication Nos. 2014/0073458 and 2007/0117923, and U.S. Patent Application Ser. No. 60/401,047, filed Aug. 6, 2002, the entire disclosures of which are hereby incorporated herein by reference;
(f) polystyrenes, such as poly(styrene-co-maleic anhydride), acrylonitrile-butadiene-styrene, poly(styrene sulfonate), polyethylene styrene;
(g) polypropylenes, polyethylenes, and copolymers of propylene and ethylene;
(h) ethylene elastomers;
(i) propylene elastomers;
(j) styrenic copolymers and styrenic block copolymers;
(k) dynamically vulcanized elastomers;
(l) polyvinyl chlorides;
(l) polyvinyl acetates, particularly those having less than about 9% of vinyl acetate by weight;
(m)polycarbonates, polycarbonate/acrylonitrile-butadiene-styrene blends, polycarbonate/polyurethane blends, and polycarbonate/polyester blends;
(n) polyvinyl alcohols;
(o) polyethers and polyether-esters;
(p) engineering thermoplastic vulcanizates, such as those disclosed, for example, in U.S. Patent Application Publication No. 2008/0132359, the entire disclosure of which is hereby incorporated herein by reference;
(q) metallocene-catalyzed polymers, such as those disclosed in U.S. Pat. Nos. 6,274,669, 5,919,862, 5,981,654, and 5,703,166, the entire disclosures of which are hereby incorporated herein by reference;
(r) fluoropolymers, such as those disclosed in U.S. Pat. Nos. 5,691,066, 6,747,110, and 7,009,002, the entire disclosures of which are hereby incorporated herein by reference; and
(s) combinations of two or more thereof.

In another embodiment, the thermoplastic composition comprising the non-migrating polymeric (meth) acrylate plasticizer is an ionomeric composition. Suitable ionomer compositions include partially neutralized ionomers and highly neutralized ionomers, including ionomers formed from blends of two or more partially neutralized ionomers, blends of two or more highly neutralized ionomers, and blends of one or more partially neutralized ionomers with one or more highly neutralized ionomers. Preferred ionomers are salts of O/X- and O/X/Y-type acid copolymers, wherein O is an α-olefin, X is a C₃-C₈ α,β-ethylenically unsaturated carboxylic acid, and Y is a softening monomer. O is preferably selected from ethylene and propylene. X is preferably selected from methacrylic acid, acrylic acid, ethacrylic acid, crotonic acid, and itaconic acid. Methacrylic acid and acrylic acid are particularly preferred. As used herein, “(meth) acrylic acid” means methacrylic acid and/or acrylic acid. Likewise, “(meth) acrylate” means methacrylate and/or acrylate. Y is preferably selected from (meth) acrylate and alkyl (meth) acrylates wherein the alkyl groups have from 1 to 8 carbon atoms, including, but not limited to, n-butyl (meth) acrylate, isobutyl (meth) acrylate, methyl (meth) acrylate, and ethyl (meth) acrylate. Particularly preferred O/X/Y-type copolymers are ethylene/(meth) acrylic acid/n-butyl (meth) acrylate, ethylene/(meth) acrylic acid/isobutyl (meth) acrylate, ethylene/(meth) acrylic acid/methyl (meth) acrylate, and ethylene/(meth) acrylic acid/ethyl (meth) acrylate. The acid is typically present in the acid copolymer in an amount of 6 wt % or greater, or 9 wt % or greater, or 10 wt % or greater, or 11 wt % or greater, or 15 wt % or greater, or 16 wt % or greater, or 19 wt % or greater, or 20 wt % or greater, or in an amount within a range having a lower limit of 1 or 4 or 6 or 8 or 10 or 11 or 12 or 15 wt % and an upper limit of 15 or 16 or 17 or 19 or 20 or 20.5 or 21 or 25 or 30 or 35 or 40 wt %, based on the total weight of the acid copolymer. The acid copolymer is at least partially neutralized with a cation source, optionally in the presence of a high molecular weight organic acid, such as those disclosed in U.S. Pat. No. 6,756,436, the entire disclosure of which is hereby incorporated herein by reference. In a particular embodiment, less than 40% of the acid groups present in the composition are neutralized. In another particular embodiment, from 40% to 60% of the acid groups present in the composition are neutralized. In another particular embodiment, from 60% to 70% of the acid groups present in the composition are neutralized. In another particular embodiment, from 60% to 80% of the acid groups present in the composition are neutralized. In another particular embodiment, from 70% to 80% of the acid groups present in the composition are neutralized. In another embodiment, from 80% to 100% of the acid groups present in the composition are neutralized. Suitable cation sources include, but are not limited to, metal ion sources, such as compounds of alkali metals, alkaline earth metals, transition metals, and rare earth elements; ammonium salts and monoamine salts; and combinations thereof. Preferred cation sources are compounds of lithium, sodium, potassium, magnesium, cesium, calcium, barium, lead, tin, zinc, aluminum, manganese, nickel, chromium, copper, or a combination thereof.

Also suitable are bimodal ionomers, for example, DuPont® AD1043 ionomers, and the ionomers disclosed in U.S. Patent Application Publication No. 2004/0220343 and U.S. Pat. Nos. 6,562,906, 6,762,246 and 7,273,903, the entire disclosures of which are hereby incorporated herein by reference.

Also suitable are polyester ionomers, including, but not limited to, those disclosed, for example, in U.S. Pat. Nos. 6,476,157 and 7,074,465, the entire disclosures of which are hereby incorporated herein by reference.

Also suitable are silicone ionomers. Suitable thermoplastic silicone ionomer compositions include a silicone ionomer optionally blended with one or more additional polymer components selected from E/X/Y-type ionomers of ethylene (E), an α,β-unsaturated carboxylic acid (X), and optionally a softening comonomer (Y); thermoplastic polyurethanes; polyesters; and polyamides. Suitable thermoset silicone ionomer compositions include a silicone ionomer optionally blended with one or more additional polymer components selected from thermosetting polyurethanes and diene rubbers, particularly polybutadienes. Silicone ionomers are further disclosed, for example, in U.S. Pat. No. 8,329,156 to Horstman et al.; U.S. Pat. No. 8,835,583 to Saxena et al.; and Batra, Ashish, Claude Cohen, and T. M. Duncan. “Synthesis and Rheology of Tailored Poly(dimethylsiloxane) Zinc and Sodium Ionomers.” Macromolecules (2005): 426-38. American Chemical Society. Web. 1 Oct. 2014; the entire disclosures of which are hereby incorporated herein by reference.

Also suitable are blends of partially- or fully-neutralized ionomers with additional thermoplastic and thermoset materials, including, but not limited to, non-ionomeric acid copolymers, engineering thermoplastics, styrenic block copolymers, polyalkenamers, polybutadienes, polyurethanes, polyureas, polyesters, polycarbonate/polyester blends, polyamides, polystyrenes, thermoplastic elastomers, metallocene-catalyzed polymers, and functionalized derivatives thereof.

In a particular embodiment, the thermoplastic composition is selected from the relatively soft HNP compositions disclosed in U.S. Pat. No. 7,468,006, the entire disclosure of which is hereby incorporated herein by reference, and the low modulus HNP compositions disclosed in U.S. Pat. No. 7,207,903, the entire disclosure of which is hereby incorporated herein by reference.

In another particular embodiment, the thermoplastic composition is selected from the relatively hard HNP compositions disclosed in U.S. Pat. No. 7,468,006, the entire disclosure of which is hereby incorporated herein by reference, and the high modulus HNP compositions disclosed in U.S. Pat. No. 7,207,903, the entire disclosure of which is hereby incorporated herein by reference.

In another particular embodiment, the thermoplastic composition is formed by blending an acid polymer, a non-acid polymer, a cation source, and a fatty acid or metal salt thereof. In a particular aspect of this embodiment, the acid polymer is selected from ethylene-acrylic acid and ethylene-methacrylic acid copolymers, optionally containing a softening monomer selected from n-butyl acrylate and iso-butyl acrylate. In another particular aspect of this embodiment, the non-acid polymer is an elastomeric polymer selected from ethylene-alkyl acrylate polymers, particularly polyethylene-butyl acrylate, polyethylene-methyl acrylate, and polyethylene-ethyl acrylate; metallocene-catalyzed polymers; ethylene-butyl acrylate-carbon monoxide polymers and ethylene-vinyl acetate-carbon monoxide polymers; polyethylene-vinyl acetates; ethylene-alkyl acrylate polymers containing a cure site monomer; ethylene-propylene rubbers and ethylene-propylene-diene monomer rubbers; olefinic ethylene elastomers, particularly ethylene-octene polymers, ethylene-butene polymers, ethylene-propylene polymers, and ethylene-hexene polymers; styrenic block copolymers; polyester elastomers; polyamide elastomers; polyolefin rubbers, particularly polybutadiene, polyisoprene, and styrene-butadiene rubber; and thermoplastic polyurethanes. The acid polymer and non-acid polymer are combined and reacted with a cation source, such that at least 80% of all acid groups present are neutralized. Ionomer compositions formed by blending an acid polymer, a non-acid polymer, a cation source, and a fatty acid or metal salt thereof are further disclosed, for example, in U.S. Patent Application Publication No. 2014/0113748, the entire disclosure of which is hereby incorporated herein by reference.

Suitable ionomer compositions are further disclosed, for example, in U.S. Patent Application Publication Nos. 2005/0049367, 2005/0148725, 2005/0020741, 2004/0220343, and 2003/0130434, and U.S. Pat. Nos. 5,587,430, 5,691,418, 5,866,658, 6,100,321, 6,562,906, 6,653,382, 6,756,436, 6,777,472, 6,762,246, 6,815,480, 6,894,098, 6,919,393, 6,953,820, 6,994,638, 7,375,151, and 7,652,086, the entire disclosures of which are hereby incorporated herein by reference.

The thermoplastic composition optionally include additive(s) and/or filler(s) in an amount of 50 wt % or less, or 30 wt % or less, or 20 wt % or less, or 15 wt % or less, based on the total weight of the thermoplastic composition. Suitable additives and fillers include, but are not limited to, chemical blowing and foaming agents, optical brighteners, coloring agents, fluorescent agents, whitening agents, UV absorbers, light stabilizers, defoaming agents, processing aids, antioxidants, stabilizers, softening agents, fragrance components, non-polymerizable plasticizers, impact modifiers, TiO₂, acid copolymer wax, surfactants, performance additives (e.g., A-C® performance additives, particularly A-C® low molecular weight ionomers and copolymers, A-C® oxidized polyethylenes, A-C® ethylene vinyl acetate waxes, and AClyn® low molecular weight ionomers, commercially available from Honeywell International Inc.), fatty acid amides (e.g., ethylene bis-stearamide and ethylene bis-oleamide), fatty acids and salts thereof (e.g., stearic acid, oleic acid, zinc stearate, magnesium stearate, zinc oleate, and magnesium oleate), oxides (e.g., zinc oxide, tin oxide, iron oxide, calcium oxide, aluminum oxide, titanium dioxide, magnesium oxide, and zirconium oxide), carbonates (e.g., calcium carbonate, zinc carbonate, barium carbonate, and magnesium carbonate), barium sulfate, zinc sulfate, tungsten, tungsten carbide, silica, lead silicate, regrind, clay, mica, talc, nano-fillers, carbon black, glass flake, milled glass, flock, fibers, and mixtures thereof. Suitable additives and fillers are more fully described in, for example, U.S. Patent Application Publication No. 2003/0225197, the entire disclosure of which is hereby incorporated herein by reference. The thermoplastic composition optionally includes one or more melt flow modifiers.

Suitable melt flow modifiers include materials which increase the melt flow of the composition, as measured using ASTM D-1238, condition E, at 190° C., using a 2160 gram weight. Examples of suitable melt flow modifiers include, but are not limited to, fatty acids and fatty acid salts, including, but not limited to, those disclosed in U.S. Pat. No. 5,306,760, the entire disclosure of which is hereby incorporated herein by reference; fatty amides; polyhydric alcohols, including, but not limited to, those disclosed in U.S. Pat. No. 7,365,128, and U.S. Patent Application Publication No. 2010/0099514, the entire disclosures of which are hereby incorporated herein by reference; polylactic acids, including, but not limited to, those disclosed in U.S. Pat. No. 7,642,319, the entire disclosure of which is hereby incorporated herein by reference; and the modifiers disclosed in U.S. Patent Application Publication No. 2010/0099514 and 2009/0203469, the entire disclosures of which are hereby incorporated herein by reference. Flow enhancing additives also include, but are not limited to, montanic acids, esters of montanic acids and salts thereof, bis-stearoylethylenediamine, mono- and polyalcohol esters such as pentaerythritol tetrastearate, zwitterionic compounds, and metallocene-catalyzed polyethylene and polypropylene wax, including maleic anhydride modified versions thereof, amide waxes and alkylene diamides such as bistearamides. Particularly suitable fatty amides include, but are not limited to, saturated fatty acid monoamides (e.g., lauramide, palmitamide, arachidamide behenamide, stearamide, and 12-hydroxy stearamide); unsaturated fatty acid monoamides (e.g., oleamide, erucamide, and ricinoleamide); N-substituted fatty acid amides (e.g., N-stearyl stearamide, N-behenyl behenamide, N-stearyl behenamide, N-behenyl stearamide, N-oleyl oleamide, N-oleyl stearamide, N-stearyl oleamide, N-stearyl erucamide, erucyl erucamide, and erucyl stearamide, N-oleyl palmitamide, methylol amide (more preferably, methylol stearamide, methylol behenamide); saturated fatty acid bis-amides (e.g., methylene bis-stearamide, ethylene bis-stearamide, ethylene bis-isostearamide, ethylene bis-hydroxystearamide, ethylene bis-behenamide, hexamethylene bis-stearamide, hexamethylene bis-behenamide, hexamethylene bis-hydroxystearamide, N,N′-distearyl adipamide, and N,N′-distearyl sebacamide); unsaturated fatty acid bis-amides (e.g., ethylene bis-oleamide, hexamethylene bis-oleamide, N,N′-dioleyl adipamide, N,N′-dioleyl sebacamide); and saturated and unsaturated fatty acid tetra amides, stearyl erucamide, ethylene bis stearamide and ethylene bis oleamide. Suitable examples of commercially available fatty amides include, but are not limited to, Kemamide® fatty acids, such as Kemamide® B (behenamide/arachidamide), Kemamide® W40 (N,N′-ethylenebisstearamide), Kemamide® P181 (oleyl palmitamide), Kemamide® S (stearamide), Kemamide® U (oleamide), Kemamide® E (erucamide), Kemamide® O (oleamide), Kemamide® W45 (N,N′-ethylenebisstearamide), Kenamide® W20 (N,N′-ethylenebisoleamide), Kemamide® E180 (stearyl erucamide), Kemamide® E221 (erucyl erucamide), Kemamide® S180 (stearyl stearamide), Kemamide® S221 (erucyl stearamide), commercially available from Chemtura Corporation; and Crodamide® fatty amides, such as Crodamide® OR (oleamide), Crodamide® ER (erucamide), Crodamide® SR (stereamide), Crodamide® BR (behenamide), Crodamide® 203 (oleyl palmitamide), and Crodamide® 212 (stearyl erucamide), commercially available from Croda Universal Ltd.

Non-limiting examples of suitable commercially available materials for use in forming the thermoplastic compositions of the present invention are Surlyn® ionomers, DuPont® HPF 1000, HPF 2000, HPF AD1035, HPF AD1040, and AD1043 ionomers, commercially available from E. I. du Pont de Nemours and Company; Clarix® ionomers, commercially available from A. Schulman, Inc.; Iotek® ionomers, commercially available from ExxonMobil Chemical Company; AClyn® ionomers, commercially available from Honeywell International Inc.; Amplify® IO ionomers, commercially available from The Dow Chemical Company; Amplify® GR functional polymers and Amplify® TY functional polymers, commercially available from The Dow Chemical Company; Fusabond® functionalized polymers, including ethylene vinyl acetates, polyethylenes, metallocene-catalyzed polyethylenes, ethylene propylene rubbers, and polypropylenes, commercially available from E. I. du Pont de Nemours and Company; Exxelor® maleic anhydride grafted polymers, including high density polyethylene, polypropylene, semi-crystalline ethylene copolymer, amorphous ethylene copolymer, commercially available from ExxonMobil Chemical Company; ExxonMobil® PP series polypropylene impact copolymers, such as PP7032E3, PP7032KN, PP7033E3, PP7684KN, commercially available from ExxonMobil Chemical Company; Vistamaxx® propylene-based elastomers, commercially available from ExxonMobil Chemical Company; Exact® plastomers, commercially available from ExxonMobil Chemical Company; Santoprene® thermoplastic vulcanized elastomers, commercially available from ExxonMobil Chemical Company; Nucrel® acid copolymers, commercially available from E. I. du Pont de Nemours and Company; Escor® acid copolymers, commercially available from ExxonMobil Chemical Company; Primacor® acid copolymers, commercially available from The Dow Chemical Company; Kraton® styrenic block copolymers, commercially available from Kraton Performance Polymers Inc.; Septon® styrenic block copolymers, commercially available from Kuraray Co., Ltd.; Lotader® ethylene acrylate based polymers, commercially available from Arkema Corporation; Polybond® grafted polyethylenes and polypropylenes, commercially available from Chemtura Corporation; Vestenamer® polyoctenamer, commercially available from Evonik Industries; Pebax® polyether and polyester amides, commercially available from Arkema Inc.; Hytrel® polyester elastomers, commercially available from E. I. du Pont de Nemours and Company; Riteflex® polyester elastomers, commercially available from Ticona; Estane® thermoplastic polyurethanes, commercially available from The Lubrizol Corporation; Grivory® polyamides and Grilamid® polyamides, commercially available from EMS Grivory; Zytel® polyamide resins and Elvamide® nylon multipolymer resins, commercially available from E. I. du Pont de Nemours and Company; Elvaloy® acrylate copolymer resins, commercially available from E. I. du Pont de Nemours and Company; Xylex® polycarbonate/polyester blends, commercially available from SABIC Innovative Plastics; and Elastollan® polyurethane-based thermoplastic elastomers, commercially available from BASF.

### Golf Ball Applications

Compositions of the present invention can be used in a variety of golf ball applications, including wound, one-piece, two-piece, and multi-layer balls, so long as at least one layer is formed from a thermoplastic composition comprising a non-migrating polymeric (meth) acrylate plasticizer. In golf balls having two or more layers formed from a composition comprising a non-migrating polymeric (meth) acrylate plasticizer, such layers may be formed from the same or different compositions. The layer(s) comprising the thermoplastic composition comprising a non-migrating polymeric (meth) acrylate plasticizer can be any one or more of an inner core layer, an intermediate layer, or an outer cover layer.

In a particular embodiment, the golf ball is a one-piece golf ball formed from a thermoplastic composition comprising a non-migrating polymeric (meth) acrylate plasticizer.

In another particular embodiment, the golf ball is a two-piece or multi-layer ball wherein at least one layer is formed from a thermoplastic composition comprising a non-migrating polymeric (meth) acrylate plasticizer. The thermoplastic composition may be present in an inner core layer, an outer cover layer, an optional intermediate layer, or a combination thereof.

In yet another particular embodiment, the invention provides a multi-layer ball having a rubber core, an intermediate layer formed from a thermoplastic composition comprising a non-migrating polymeric (meth) acrylate plasticizer, and a polyurethane or polyurea outer cover layer. Preferably, the rubber core composition comprises a base rubber, a crosslinking agent, a filler, a co-crosslinking or initiator agent, and a cis to trans converting material (e.g., organosulfur and inorganic sulfur compounds). Typical base rubber materials include natural and synthetic rubbers, including, but not limited to, polybutadiene and styrene-butadiene. The crosslinking agent typically includes a metal salt, such as a zinc salt or magnesium salt, of an acid having from 3 to 8 carbon atoms, such as (meth) acrylic acid. The initiator agent can be any known polymerization initiator which decomposes during the cure cycle, including, but not limited to, dicumyl peroxide, 1,1-di-(t-butylperoxy) 3,3,5-trimethyl cyclohexane, a-a bis-(t-butylperoxy) diisopropylbenzene, 2,5-dimethyl-2,5 di-(t-butylperoxy) hexane or di-t-butyl peroxide, and mixtures thereof. Suitable types and amounts of base rubber, crosslinking agent, filler, co-crosslinking agent, and initiator agent are more fully described in, for example, U.S. Patent Application Publication No. 2003/0144087, the entire disclosure of which is hereby incorporated herein by reference. Reference is also made to U.S. Patent Application Publication No. 2003/0144087 for various ball constructions and materials that can be used in golf ball core, intermediate, and cover layers.

The present invention is not limited by any particular process for forming the golf ball layer(s). It should be understood that the layer(s) can be formed by any suitable technique, including injection molding, compression molding, casting, and reaction injection molding

Golf balls of the present invention typically have a coefficient of restitution (COR) of 0.700 or greater, preferably 0.750 or greater, more preferably 0.780 or greater, and even more preferably 0.790 or greater.

COR, as used herein, is determined according to a known procedure wherein a golf ball or golf ball subassembly (e.g., a golf ball core) is fired from an air cannon at two given velocities and calculated at a velocity of 125 ft/s. Ballistic light screens are located between the air cannon and the steel plate at a fixed distance to measure ball velocity. As the ball travels toward the steel plate, it activates each light screen, and the time at each light screen is measured. This provides an incoming transit time period inversely proportional to the ball's incoming velocity. The ball impacts the steel plate and rebounds though the light screens, which again measure the time period required to transit between the light screens. This provides an outgoing transit time period inversely proportional to the ball's outgoing velocity. COR is then calculated as the ratio of the outgoing transit time period to the incoming transit time period, COR=Vₒᵤₜ/Vᵢₙ=Tᵢₙ/Tₒᵤₜ.

Golf balls of the present invention typically have an overall compression of 40 or greater, or a compression within a range having a lower limit of 40 or 50 or 60 or 65 or 75 or 80 or 90 and an upper limit of 95 or 100 or 105 or 110 or 115 or 120.

Compression is an important factor in golf ball design. For example, the compression of the core can affect the ball's spin rate off the driver and the feel. As disclosed in Jeff Dalton's Compression by Any Other Name, Science and Golf IV, Proceedings of the World Scientific Congress of Golf (Eric Thain ed., Routledge, 2002) (“J. Dalton”), several different methods can be used to measure compression, including Atti compression, Riehle compression, load/deflection measurements at a variety of fixed loads and offsets, and effective modulus. For purposes of the present invention, “compression” refers to Atti compression and is measured according to a known procedure, using an Atti compression test device, wherein a piston is used to compress a ball against a spring. The travel of the piston is fixed and the deflection of the spring is measured. The measurement of the deflection of the spring does not begin with its contact with the ball; rather, there is an offset of approximately the first 1.25 mm (0.05 inches) of the spring's deflection. Very low stiffness cores will not cause the spring to deflect by more than 1.25 mm and therefore have a zero compression measurement. The Atti compression tester is designed to measure objects having a diameter of 42.7 mm (1.68 inches); thus, smaller objects, such as golf ball cores, must be shimmed to a total height of 42.7 mm to obtain an accurate reading. Conversion from Atti compression to Riehle (cores), Riehle (balls), 100 kg deflection, 130-10 kg deflection or effective modulus can be carried out according to the formulas given in J. Dalton.

The United States Golf Association specifications limit the minimum size of a competition golf ball to 1.680 inches. There is no specification as to the maximum diameter, and golf balls of any size can be used for recreational play. Golf balls of the present invention can have an overall diameter of any size. The preferred diameter of the present golf balls is from 1.680 inches to 1.800 inches. More preferably, the present golf balls have an overall diameter of from 1.680 inches to 1.760 inches, and even more preferably from 1.680 inches to 1.740 inches.

When numerical lower limits and numerical upper limits are set forth herein, it is contemplated that any combination of these values may be used.

All patents, publications, test procedures, and other references cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those of ordinary skill in the art without departing from the spirit and scope of the invention. Accordingly, it is not intended that the scope of the claims appended hereto be limited to the examples and descriptions set forth herein, but rather that the claims be construed as encompassing all of the features of patentable novelty which reside in the present invention, including all features which would be treated as equivalents thereof by those of ordinary skill in the art to which the invention pertains.

What is claimed is:

1. A golf ball comprising at least one layer formed from a thermoplastic composition, the thermoplastic composition comprising a polymeric plasticizer selected from the group consisting of C₅-C₅₀ alkyl acrylates and C₅-C₅₀ alkyl methacrylates in an amount of 5 wt % or greater, based on the total polymeric weight of the thermoplastic composition.

2. The golf ball of claim 1, wherein the thermoplastic composition is an ionomeric composition.

3. The golf ball of claim 1, wherein the polymeric plasticizer is selected from the group consisting of lauryl acrylate, lauryl methacrylate, isodecyl acrylate, isodecyl methacrylate, 2-ethylhexyl acrylate, 2-ethylhexyl methacrylate, tridecyl acrylate, tridecyl methacrylate, stearyl acrylate, and stearyl methacrylate.

4. The golf ball of claim 1, wherein the polymeric plasticizer is present in the thermoplastic composition in an amount of from 5 wt % to 70 wt %, based on the total polymeric weight of the thermoplastic composition.

5. The golf ball of claim 1, wherein the polymeric plasticizer is present in the thermoplastic composition in an amount of from 5 wt % to 60 wt %, based on the total polymeric weight of the thermoplastic composition.

6. The golf ball of claim 1, wherein the polymeric plasticizer has a M_{w} of less than 10,000.

7. The golf ball of claim 1, wherein the polymeric plasticizer has a M_{w} of 5,000 or less.

8. The golf ball of claim 1, wherein the polymeric plasticizer has a M_{w} of 2,000 or less.

9. The golf ball of claim 1, wherein the polymeric plasticizer has a M_{w} of from 100 to 2,000.

10. The golf ball of claim 1, wherein the polymeric plasticizer has a M_{w} of from 300 to 2,000.

11. The golf ball of claim 1, wherein the golf ball comprises an inner core layer and an outer cover layer, wherein the inner core layer is formed from the thermoplastic composition.

12. The golf ball of claim 1, wherein the golf ball comprises an inner core layer, an outer cover layer, and an intermediate layer disposed between the inner core layer and the outer cover layer, and wherein the intermediate layer is formed from the thermoplastic composition.

13. A golf ball comprising at least one layer formed from a thermoplastic composition, the thermoplastic composition comprising 5 wt % or greater, based on the total polymeric weight of the thermoplastic composition, of a polymeric plasticizer having a M_{w} of less than 10,000 and selected from the group consisting of C₅-C₅₀ alkyl acrylates and C₅-C₅₀ alkyl methacrylates.

14. The golf ball of claim 13, wherein the thermoplastic composition is an ionomeric composition.

15. The golf ball of claim 13, wherein the polymeric plasticizer is selected from the group consisting of lauryl acrylate, lauryl methacrylate, isodecyl acrylate, isodecyl methacrylate, 2-ethylhexyl acrylate, 2-ethylhexyl methacrylate, tridecyl acrylate, tridecyl methacrylate, stearyl acrylate, and stearyl methacrylate.

16. The golf ball of claim 13, wherein the polymeric plasticizer is present in the thermoplastic composition in an amount of from 5 wt % to 70 wt %, based on the total polymeric weight of the thermoplastic composition.

17. The golf ball of claim 13, wherein the polymeric plasticizer is present in the thermoplastic composition in an amount of from 5 wt % to 60 wt %, based on the total polymeric weight of the thermoplastic composition.

18. The golf ball of claim 13, wherein the golf ball comprises an inner core layer and an outer cover layer, wherein the inner core layer is formed from the thermoplastic composition.

19. The golf ball of claim 13, wherein the golf ball comprises an inner core layer, an outer cover layer, and an intermediate layer disposed between the inner core layer and the outer cover layer, and wherein the intermediate layer is formed from the thermoplastic composition.
